(19) United States
(12) Patent Application Publication
(10) Pub. No.: US 2007/0033110 A1
(43) Pub. Date: Feb. 8, 2007

(54) Systems, methods, and computer program products for relieving usage overloads in computer inventory systems by detecting and relaying pricing changes to a user

(75) Inventors: Dominique Philipp, Dallas, TX (US); Walt Kochan, Trophy Club, TX (US); Joshua Hartmann, Brooklyn, NY (US); Dipika Kapadia, Keller, TX (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Travelocity.com LP

(21) Appl. No.: 11/198,255

(22) Filed: Aug. 5, 2005

(51) Int. Cl. G06Q 30/00

(52) U.S. Cl. 705/26

(57) ABSTRACT

A system, method, and computer program product are provided for automatically identifying pricing changes and issuing rebates based on pricing changes occurring between a time of purchase and the usage time of a selected product option that has been previously purchased from a product database. The system of the present invention interrogates the product database, such as a travel reservation system, for current pricing corresponding to the selected product option and automatically compares the purchase price of the selected product option to the current pricing in order to determine if a user of the system should be issued a credit based on the difference between the purchase price and current price of the selected product option.

### BACKGROUND OF THE INVENTION

1. Field of the Invention

The present invention relates to the field of computerized inventory systems, such as airline reservations systems or other product and/or service reservation or inventory systems, which are used to determine availability and pricing for products and/or services. More particularly, the systems, methods, and computer program products of the present invention relate to the automated identification of pricing and/or promotion changes for purchased products and the issuance of rebates based on the changes in price and/or promotions for the purchased products and/or services.

2. Description of Related Art

Many of today's products and services are catalogued in computerized reservation or inventory systems. These systems may include simple or complex methodologies for maintaining inventory and providing product and/or service availability information. Either via direct access or remote access across a network, consumers can run queries and view availability information for selected products and/or services, as well as purchase or reserve such items. One example of such systems is a computerized reservation system (CRS). A CRS provides a communications network for travel agents and other consumers to access travel related information such as airline tickets, hotel reservations, car rentals, event tickets, leisure activities, etc. CRS systems have been in existence for a long period of time. Some of the current CRS systems are known or referred to under the following trade names and services marks: SABRE, AMADEUS, WORLDSPAN, SYSTEM ONE, APOLLO, GEMINI, GALILEO, AND AXESS.

Consumer interaction with these systems has evolved in recent years. Initially, these systems were difficult to use and did not always provide the best solution to a consumer's query. For example, in the early stages, a consumer interested in booking airline tickets would input a desired flight itinerary with desired travel dates and times and possible selected class of travel. The CRS system would check availability for the dates and return with a fare price meeting the specific input dates and times requested. Although there were some algorithms in place to aid the consumer in finding the lowest-priced fare, these algorithms were typically geared more toward providing quick results with less computing time and resources than in finding the lowest priced fare. For example, some early product availability and booking algorithms used a method that would heuristically select a subset of itineraries from a larger pool of itineraries, price this subset, and select the lowest-priced fare from the subset for display to the consumer. While these early systems provided timely results and reduced processing load on the CRS, they did not always provide the best solution to the consumer.

In light of this, Sabre developed an algorithm, (sometimes referred to as extended implicit enumeration algorithm), that could be used to efficiently determine the lowest fare for a particular flight itinerary. The algorithm used a k-shortest path schema that identified the lowest available fare that met a consumer's request and displayed this fare to the consumer. This algorithm is described more fully in U.S. patent application Ser. No. 09/421,895, filed on Oct. 21, 1999, entitled: Method and Apparatus for Searching for a Low Fare for Travel Between Two Locations, and published as a PCT application under publication number WO0129693; the contents of which are incorporated herein.

The extended implicit enumeration algorithm was a major step forward in efficiently determining the lowest fare price for a given itinerary; it does have a few slight drawbacks. Specifically, the algorithm was designed to provide a small number of low priced answers with minimal consideration of diversity. The consumer inputs a request, and the algorithm returns only the lowest fare meeting the request. Unfortunately, such a process may not provide the best solution to a consumer or may miss an opportunity to market different fares to a customer that may maximize profits for the supplier, while also meeting the consumer's goals. Thus the assignee of the present invention developed a system, method, and computer program product to provide a plurality of low fare prices and different flight itinerary options for a given departure and return date combination, thereby allowing a user to view these different options and make a determination as to which fare and flight itinerary meets their goals as described more fully in U.S. Provisional Patent Application Ser. No. 60/573,546, filed on May 21, 2004, entitled, Systems, Methods, And Computer Program Products For Searching And Displaying Low Cost Product Availability Information For A Given Departure-Return Date Combination Or Range Of Departure-Return Date Combinations; the contents of which are also incorporated herein.

While conventional searching systems for low cost products may provide a user with a multitude of different product options including, in some cases, the lowest possible price for a given product option at the time of the search, conventional searching systems do not automatically and periodically review the pricing available for a given pricing option (such as a selected travel itinerary corresponding to an airline ticket). This technical problem is especially apparent in conventional systems for searching for travel itinerary product options, wherein pricing for a given itinerary may vary in the time between the purchase of the itinerary and the date of travel departure. In addition, conventional systems do not present the option to a user to select and/or purchase an automated pricing review so as to solve the technical problems that arise in conventional search systems wherein search system resources are unduly burdened by users manually searching for pricing changes corresponding to the selected product in the time period identified above. For example, some operators of conventional travel ticket search systems offer a “price-match” guarantee whereby a user may manually search for pricing changes in their selected travel itinerary, print out proof of such a pricing change, and subsequently present such proof to the operator in order to receive a refund. Such offers often exacerbate the technical problems of conventional search systems wherein a number of users may repeatedly search for pricing changes corresponding to the selected product option in order to obtain the promised refund.

Therefore, there exists a need for an improved system to solve the technical problems outlined above that are associated with conventional search systems. More particularly, there exists a need for a system capable of automatically searching a product database for pricing changes corresponding to a selected product option that may occur between the time of purchase and the time of product use (such as the departure date of a travel itinerary). There also exists a need for such a system that automatically prompts a user to select and/or purchase the automated pricing change monitor as well as a system that may automatically issue a rebate to a user for the difference between the purchase price of a given product option (such as a ticket for air travel) and a lower price detected by the system during the time period between the purchase time and the time of product use (for example, the date on which the user departs on the first departure leg of a travel itinerary).

### BRIEF SUMMARY OF THE INVENTION

The needs outlined above are met by the present invention which, in various embodiments, provides a system that overcomes many of the technical problems discussed above, as well other technical problems, with regard to the monitoring of pricing and promotional changes corresponding to product options purchased via conventional product search systems. Specifically, in one embodiment, the system provided is capable of automatically monitoring a product database for changes in price corresponding to a product option purchased by a user from a plurality of product options listed in the product database. For example, in some embodiments, the system may comprise a product database or product source system, such as a CRS, containing travel itineraries and prices and promotions corresponding to the travel itineraries.

More specifically, the system of the present invention comprises, in one embodiment, a product source system comprising product options information concerning one or more products, an accounting system for receiving payments from users for product options selected for purchase, an interface capable of receiving input from a user concerning purchase of a selected product option, and a product availability and purchasing system in communication with the product source system, accounting system, and interface. Furthermore, the product availability and purchasing system comprises a memory device for storing purchase information related to products purchased by the user and a processing element in communication with the interface and the product source system. The processing element is capable, for example, of determining availability and pricing for the selected product option received from the interface and of storing purchasing information, including the purchase price paid by the user, in a first data set, that is associated with the selected product option, in the memory device. In addition, the processing element periodically interrogates the product source system and determines a current purchase price for the selected product option and compares the current purchase price to the stored purchase price paid by the user for the selected product option. Thus, according to some embodiments of the system, if the current purchase price is less than the purchase price paid by the user, the processor activates the accounting system to issue a credit for at least a portion of the difference in price.

According to other system embodiments of the present invention, the product source system may also comprise a data cache for storing product availability and pricing information received from other product source systems (such as a separate CRS, for example). Furthermore, the system embodiments of the present invention may also monitor a product database for changes in a status corresponding to a product option purchased by a user where various promotional offers, such as free service upgrades or another first set of promotions that may be associated with the product option and changed from time to time. In such embodiments, the processing element of the product availability and purchasing system periodically interrogates the product source system and determines a second set of promotions that may be currently offered with the selected product option and then compares the second set of promotions to the first set of promotions (stored by the memory device of the product availability and purchasing system) and indicates when there is a difference between the first and second sets of promotions.

The present invention also includes methods and computer program product embodiments for automatically monitoring a product database (such as a CRS, for example) for changes in price corresponding to a product option (such as a particular travel itinerary) purchased by a user from a plurality of product options listed in the product database. According to one embodiment, the method and computer program products comprises the following steps and corresponding computer instruction means: receiving from a user a commitment to purchase a selected product for a selected purchase price; and storing information concerning the purchase, including the purchase price paid by the user, in a storage device. Following the purchase of the product, the method and computer program product further comprise interrogating a product source system and determining a current purchase price for the selected product option and comparing the current purchase price to the stored purchase price paid by the user for the selected product option. Furthermore, if the current purchase price is less than the purchase price paid by the user, the method and computer program product further comprise the step (or corresponding computer instruction means) for issuing a credit for at least a portion of the difference in price.

According to other method and computer program product embodiments, the comparing step further comprises comparing the difference between current purchase price and the purchase price paid to a threshold value. In addition, the issuing step comprises issuing a credit to the user if the difference is at least equal to the threshold. Furthermore, in some embodiments, the interrogating step comprises interrogating the product source for updates on the current purchase price for the selected product option periodically during a specified time period after the purchase date of the selected option wherein the specified time period may end prior to the use of the purchased product. In some embodiments, the selected product option (such as a ticket corresponding to a round-trip travel itinerary) is divided into separate usable portions (such as a departure ticket and a return ticket). In such embodiments, the issuing step further comprises issuing a credit after the user has commenced use of the one of the usable portions (such as the departure ticket) of the selected product option.

In other method and computer program product embodiments, the process of comparing the stored purchase price paid by the user to the current purchase price is designated as a purchase option associated with the selected product option. Thus, the user may elect to purchase a pricing or promotional comparison service as part of the purchase option that may be accomplished by the method and computer program product embodiments of the present invention. Such embodiments further comprise the step of charging a fee to the user for the purchase option. According to some method embodiments, such a fee is varied for the purchase option based on the purchase date of the product option and a intended use date of the selected product option by the user. Additional method and computer program product embodiments may further comprise the step of storing product availability and pricing information received from other product source systems. In addition, and as described above with regard to the system embodiments of the present invention, the methods and computer program products of the present invention may also be used to monitor changes in status corresponding to a product option purchased by a user where various promotional offers (such as free upgrades, frequent flyer bonuses, or other promotions) may be associated with the product option and changed from time to time.

Thus the systems, methods, and computer program products for automatically monitoring a product database for changes in price and promotional offers, as described in the embodiments of the present invention, provide many advantages that may include, but are not limited to: relieving usage overloads in the product database by automatically identifying pricing and promotional offer changes for a plurality of users utilizing the system of the present invention; providing an automated pricing and promotional offer monitor for a product database that may enable users to more efficiently and effectively monitor the database for pricing changes and changes in promotional offers that may be in the user's favor; and automatically calculating and providing a credit to the user of the present invention that is approximately equivalent to an identified pricing or value change that has occurred in the user's favor in the time since the purchase of the product option. The various system, method, and computer program embodiments of the present invention may be ideally suited for efficiently identifying pricing and promotional changes in purchased product options (such as travel itineraries) by periodically interrogating product databases (such as a CRS) and for relieving burdens exerted on such databases by users manually seeking to identify pricing and promotional changes for a previously purchased itinerary reservation.

These advantages and others that will be evident to those skilled in the art are provided in the system, method, and computer program product of the present invention.

### BRIEF DESCRIPTION OF THE SEVERAL VIEWS OF THE DRAWINGS

Having thus described the invention in general terms, reference will now be made to the accompanying drawings, which are not necessarily drawn to scale, and wherein:

FIGS. 1A and 1B illustrate a system for monitoring a product database for changes in price corresponding to a product option purchased by a user according to one embodiment of the present invention;

FIG. 2 is an exemplary results page in the form of a web page illustrating the option offered to the user to request price protection according to one embodiment of the present invention.

FIG. 3 is a flow chart illustrating the steps performed according to one embodiment of the method of present invention;

FIG. 4 is a flow chart illustrating the steps performed according to one embodiment of the method of present invention including the step of comparing a difference between a current purchase price and a price paid for a selected product option to a threshold amount;

FIG. 5 is a flow chart illustrating the steps performed according to one embodiment of the method of present invention including the step of charging a fee to a user for initiating the subsequent method steps; and

FIG. 6 is a flow chart illustrating the steps performed according to one embodiment of the method of present invention including comparison of promotions and/or options currently associated with the product with the promotions and/or options offered at the time the product was purchased.

### DETAILED DESCRIPTION OF THE INVENTION

The present inventions now will be described more fully hereinafter with reference to the accompanying drawings, in which some, but not all embodiments of the invention are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

The various aspects of the present invention mentioned above, as well as many other aspects of the invention are described in greater detail below. While the systems, methods, and computer program products of the present invention are described in an airline ticket reservation environment, it should be understood that this is only one non-limiting example of the possible use of the embodiments of the present invention. More specifically, the system, method, and computer program product embodiments of the present invention may be adapted to any number of products and services and are not limited to the monitoring of pricing changes of previously purchased low-cost product options provided in the airline industry (via a database such as a CRS). For example, the present invention may be used to automatically monitor changes in pricing and promotions related to various products that may include, but are not limited to, hotels, cruises, rail itineraries, bus itineraries, ferry itineraries, restaurants, car rentals, sports events, and leisure activities.

The systems and methods of the present invention may be adopted to analyze any portion of a sales transaction for changes in the transaction from the time of purchase to time of use or delivery of the product. For example, the systems and methods can analyze options offered with an item at the time of purchase versus changes in options offered between the time of purchase and time of use or delivery. For example, if the product is a rental car purchased one week in advance, but later a free upgrade is offered for the same price. The systems and methods would offer the purchaser the upgrade benefit. The item could be a hotel package with two golf outings at the time of purchase, but prior to use a third golf outing is offered for the same price, the system would offer the upgrade to the user.

The embodiments discussed below generally discuss that a change in value is automatically applied to the customer. In some embodiments, the change may not be automatically applied. Instead, the change may be offered to the purchaser for review and decision. For example, if the item was a hotel package that was offered initially with a golf package, but later is offered with a water sports package, the system may offer the package change to the user. The system 10 of the present invention may also be capable of periodically updating a user with regard to pricing and/or promotional changes related to a selected product via website (accessible to users via interfaces 18 in communication with a network 14 as generally described below). In other embodiments, the user may be periodically informed via personal email, automated phone call, or other notification method of the day-to-day pricing and/or promotional changes associated with a selected product option. The user may also be provided with information via a web site page that indicates price changes.

In addition, the embodiments discussed below generally disclose that a user need actually purchase a product (such as a travel ticket) in order to apply the system and methods of the present invention to identify and credit the user for changes in price. In some embodiments, however, the user may engage the system of the present invention (by purchasing a product option pricing “option”) to “bet” that the price will drop between the time of “option” purchase and some predetermined time subsequent to the purchase of the “option.” Thus, the system of the present invention may be configured to credit a user who purchases such a pricing “option” even if the user does not actually purchase the underlying product to which the price applies. The user can exercise the option and take the credit when purchasing the product.

It is noted here that the term customer and user may both used herein. These terms are for the most part used interchangeably. User may sometimes be used to refer to individuals or entities that maintain the system, as opposed to individuals or entities that purchase product. Further, the terms “departure dates” and “return dates” are used herein as specific to embodiments in which the product option is an airline ticket or a particular travel ticket itinerary. It is understood that other products with which the present invention is used may use the terms “start date of use” and “length of use.” For example, if the product is a hotel room, the start date would be the day the customer arrives, and the customer would stay for a number of nights representing a length of stay, as opposed to use of a return date.

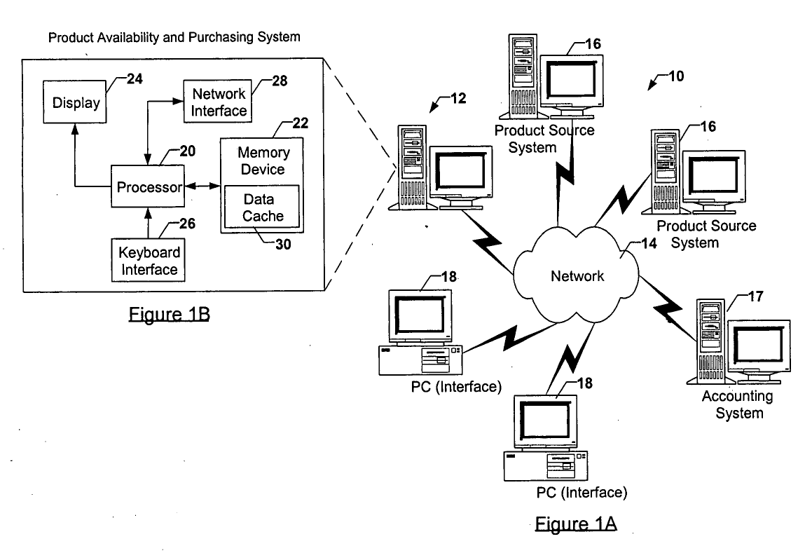

FIGS. 1A and 1B illustrate an example of a system 10 for monitoring a product database (such as a product source system 16 or reservation system) for changes in price corresponding to a product option purchased by a user. The system includes a product availability and purchasing system 12 (operating, for example on a host computer 12) that operates a web site or other similar customer interface. The host computer 12 is typically connected to a network 14, such as a LAN, WAN, Intranet, or Internet, for example.

Also connected to the network are various product source systems 16 (such as reservation systems, for example) for different products sources, such as hoteliers, airlines, car rental companies, etc. The product source systems 16 may also comprise, for instance, computerized reservation systems (CRS) for airline ticket sales. Further, customers are also connected to the network via interfaces 18, such as personal computers or other types of computing systems. In addition, accounting systems 17 for receiving payments from users for product options selected for purchase (from the product source systems 16, for example) are also in communication with the network 14. While the host computer, accounting system, product source system, and user system are shown as separate systems, it is understood that the system may all be a common computing system or some of the system may be the same computing system.

According to various embodiments of the present invention, the system 10 may monitor (via push and/or pull mechanisms) multiple product source systems 16 or reservation systems with which the operators of the system may or may not have a pre-existing commercial relationship. For example, the system 10 may be configured to be capable of monitoring a number of different product source systems 16 including reservation systems having a direct commercial relationship with the system 10 of the present invention, as well as other product source systems 16 that may be generally or publicly accessible via a network 14.

Thus, the system 10 for monitoring a product database for changes in price corresponding to a product option purchased by a user, according to one embodiment of the present invention, comprises one or more product source systems 16 (such as a CRS or other independent reservation system) comprising product options information (such as ticket price, itinerary availability, and/or promotional offers) concerning one or more products (such as travel tickets). The system 10, as described above, also comprises an accounting system 17 for receiving payments from users for product options selected for purchase. The accounting system 17 may be housed in a computer device and in communication with the system 10 via the network 14 as shown in FIG. 1B and may, in some embodiments, be housed in the processing element 20 of the product availability and purchasing system (which may be, in turn, housed in a host computer 12) described in further detail below. The system 10 embodiment shown in FIGS. 1A and 1B further comprises an interface 18 (such as a user's personal computer in communication with the network 14) that may be capable of receiving input (such as keystrokes, mouse clicks, or other inputs that will be appreciated by those skilled in the art) from a user concerning purchase of a selected product option.

In some embodiments, the product availability and purchasing system, via the host computer 12, may provide a web page or other similar electronic form to the user's interface 18 via the network 14 such that the user may select and purchase a given product option (such as a round-trip ticket for a selected travel itinerary). More particularly, using the web page, the user may input a query related to the product options information related to one or more products (such as travel itineraries and ticket prices corresponding to such itineraries). Based on such a query, the product availability and search system 12 may interrogate the product source systems 16 of various product providers for availability and pricing information. The product availability and search system 12 may assimilate the results of these queries and provide them as product options (such as various travel itineraries and available pricing and promotional offers corresponding to the itineraries) in a web page or other electronic form to a user such that the user may select and purchase one or more of the product options. The product availability and search system 12 may then store the purchasing information associated with the purchased product option (including the purchase price paid by the user) in a first data set within the memory device 22 of the host computer 12.

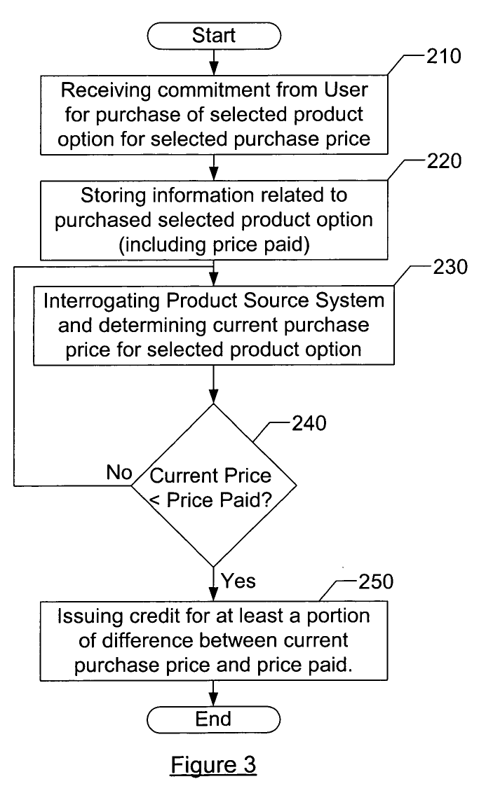

As described in further detail below, some embodiments of the system of the present invention may then be capable of periodically comparing the purchase price paid to the current purchase price for the selected option. Furthermore, the comparing step (as shown in step 240 of FIGS. 3, 4, and 5) performed by the processing element 20 of the host computer 12 may be further designated as a purchase option associated with the selected product option. In such embodiments, the processing element 20 may communicate with the accounting system 17 to charge a fee to the user for the purchase option (corresponding to the initiation of the periodic interrogation of the product source systems 16 for current purchase prices that may be substantially lower than the price paid for the selected product option). In such embodiments, the fee charged by the accounting system 17 for the product option may be varied by the processing element 20 of the product availability and purchasing system 12 based on the purchase date of the selected product option and an intended use date of the selected product option by the user. For example, the fee charged for searching for a lower current purchase price may be higher in cases where the purchase is made well in advance of the use date, as there is a greater chance that the price will change during the interim period. Where the purchase is made closer to the use date, the cost of the service may be less, as there is less chance that there will be a lowering in price close to the use date. In some embodiments, the fee charged for the purchase option may also be varied based on other factors including, but not limited to: product option purchase price (flat fee or percentage based on purchase price); product option type; product option user type (i.e., passenger type (senior, adult, child)); number of passengers; and/or product option purchaser profile (i.e., preferred, elite, and/or first-time status). The product option type may include, for example, a fare type, product option provider (i.e., carrier), international vs. domestic itineraries, round-trip/one-way/multi-city travel itineraries, and/or product option “bundles” (i.e., air itinerary bundled with a hotel, cruise, or other product option).

As illustrated in exploded FIG. 1B, the host computer 12 provided in some system embodiments of the present invention is generally embodied as a typical computer, server or mainframe system depending on the embodiment. The host computer 12 generally includes a processing element 20, such as a microprocessor, VLSI, ASIC, etc., a storage device 22, display 24, keyboard and mouse interface 26, and a network interface 28 configured to allow the host computer 12 to communicate with the network 14 of the system 10 of the present invention.

In some embodiments, the host computer 12 (and the product availability and search system housed therein) interrogates (in a pull configuration) the various product source systems 16 for product availability information each time a consumer enters a request via the interface 18 and periodically after the purchase of a particular product option (as described in the system, method, and computer program product embodiments of the present invention). However, in some embodiments, such frequent availability requests can slow down or disrupt the product source systems 16. Further, accessing the product source systems 16 may have an associated processing delay. For this reason, in some embodiments, the host computer 12 may further include a prepopulated data cache 30 from which availability information is derived for customer requests. Specifically, as shown in FIG. 11B, the host computer 12 of the present invention includes an availability cache 30 located, for example, in the memory device 22. The availability cache 30 is populated with various product availability information needed to properly respond to availability requests issued by customers. In addition product availability information stored in the availability cache 30 may further be used to generate current price and promotional information related to a purchased product option.

As shown in the exploded view of the host computer 12 in FIG. 1B, the system 10 embodiment of the present invention may comprise a product availability and purchasing system 12 in communication with the product source system 16, accounting system 17, and interface 18 in order to form one system 10 embodiment. According to some embodiments, the product availability and purchasing system 12 comprises a memory device 22 for storing purchase information related to products purchased by a user and a processing element 20 in communication with the interface 18 and one or more product source systems 16. The processing element 20 may be housed in a computer device (including, for example, the host computer 12), microprocessor, or other electronic device as will be appreciated by one skilled in the art, such that the processing element 20 may be capable of determining the availability and pricing for the selected product option received from a user via the interface 18. In addition, the processing element 20 may also store purchasing information associated with the selected product option, including, for example, the purchase price paid by the user for the selected product option and promotional offers accepted by the user in conjunction with the purchase of the product option, in a first data set in the memory device 22.

Furthermore, in one embodiment, the processing element 20 of the product availability and purchasing system 12 periodically interrogates (via the network 14, for example) the product source systems 16 and determines a current purchase price for the selected product option (that has been previously purchased by the user). The processing element 20 further compares the current purchase price to the purchase price paid by the user for the selected product option (which is stored, for example, in the memory device 22 of the product availaibility and purchasing system 12). Furthermore, the comparing step (as shown in step 240 of FIGS. 3, 4, and 5) performed by the processing element 20 of the host computer 12 may be further designated as a purchase option associated with the selected product option. In such embodiments, the processing element 20 may communicate with the accounting system 17 to charge a fee to the user for the purchase option (corresponding to the initiation of the periodic interrogation of the product source systems 16 for current purchase prices that may be substantially lower than the price paid for the selected product option). In such embodiments, the fee charged by the accounting system 17 for the product option may be varied by the processing element 20 of the product availability and purchasing system 12 based on the purchase date of the selected product option and an intended use date of the selected product option by the user. For example, the fee charged for searching for a lower current purchase price may be higher in cases where the purchase is made well in advance of the use or delivery date.

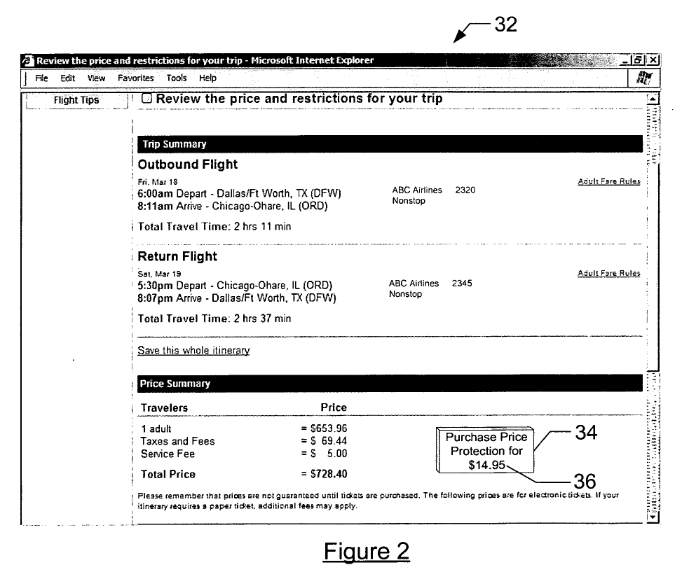

FIG. 2 illustrates an interface 32 by which the user may select a purchase option. For example, FIG. 2 illustrates a web page served by the host computer to the user's computer. In the illustrated embodiment, the user has requested pricing and availability for a product and has received results. The user is preparing to purchase the item and the interface includes a selection button 34 that allow the user to purchase price protection for a fee 36. By selecting this button and completing the transaction, the user will have initiated the purchase protection option discussed herein.

Thus, according to some embodiments of the present invention, the user (via the user interface 18 and network 14) may initiate the method steps of the present invention (shown, for example in FIGS. 3-5) by purchasing the purchase option such that the processing element 20 is activated to periodically review the current prices for a selected airline itinerary previously purchased by the user. Furthermore, if said current purchase price is less than the purchase price paid by the user, the processing element 20 subsequently activates the accounting system 17 to issue a credit for at least a portion of the difference in price.

According to various embodiments of the system 10 and methods of the present invention, the processing element 20 of the host computer 12 may interrogate the product source systems 16 (and, in some cases current product pricing and promotional information stored in the availability cache 30) for updates on the current purchase price and current promotional offers associated with a product option that has been previously selected and purchased by a user. Such interrogations may occur during a specified time period subsequent to the purchase of the selected option. Further, the specified time period for interrogation may, in some embodiments, end prior to the use of the purchased product.

The product availability and purchasing system housed in the host computer 12 may review current pricing for a purchased product option (such as a particular round-trip airline ticket itinerary) at a specified frequency per 24 hour period during the period extending from the day after selection and purchase of the ticket through the day before the scheduled departure date. For example, the product availability and purchasing system may review current pricing at various frequencies including, but not limited to, once daily, twice daily, once weekly, twice weekly, or at other frequencies. Thus, the system 10 of the present invention may selectively interrogate the product source systems 16 during off-peak usage times or selectively download current price information for the selected product option from the product source systems 16 into the availability cache 30 of the memory device 22. In addition, selected interrogation periods may be chosen corresponding to periods where current purchase prices and promotional offers are expected to change in favor of the user (for example, the purchaser of the product option).

The above description describes a pull mode, whereby the system periodically interrogates the product sources for price and other product offering changes. In other embodiments, however, the system may operate in a push mode, whereby the product sources send information to the system when there has a been a change in the product price or other product offering changes, such as is described in U.S. patent application Ser. No. 09/276,825, filed Mar. 26, 1999, entitled Event Based System For Distributing Travel Information, and assigned to the assignee of the present application. The system may also use both push and pull technologies together to receive price and other offer changes.

In some embodiments of the system 10 of the present invention, the processing element 20 further compares the difference between current purchase price (detected by interrogating the product source systems 16 or by reviewing current purchase pricing stored in an availability cache 30) and the purchase price paid by the user to a threshold value (that may be stored in the memory device 22 of the host computer 12) and subsequently communicates with the accounting system 17 to issue a credit to the user if the difference is at least equal to the threshold. Thus, the host computer 12 (and the product availability and purchasing system housed therein) may ignore slight differences in price (less than $5.00 U.S., for example) when determining whether or not to activate the accounting system 17 to issue a credit to the user. According to other embodiments, the selected product option purchased by the user may be divided into separate usable portions (such as a departure ticket and a return ticket corresponding to the outbound and return legs of a round-trip travel itinerary) such that the processing element 20 only communicates with the accounting system 17 to issue a credit to the user after the user has commenced use of one of the usable portions (i.e., used the ticket to travel on the outbound leg of the itinerary) of the selected product option.

While the system 10 embodiments of the present invention are described above with respect to the processing element's 20 capability of comparing the purchase price paid by the user for a selected product option to the current purchase price for the selected product option, the processing element 20 may also be configured to be capable of storing a first set of promotional information offered with the selected product option at the time of purchase in the memory device 22 of the host computer 12. The stored first set of promotional information corresponding to an offer (such as an upgrade offer, for example) may, in some embodiments, be explicitly requested by a user at the time of purchase of the product option. In other embodiments, the system of the present information may automatically request any upgrades (corresponding to a first set of promotional information) that may be available in conjunction with the product option at the time of purchase. Furthermore, the system 10 of the present invention In addition, the processing element may further be capable of periodically interrogating the product source systems 16 to determine a second set of promotions (that may be currently offered with the selected product option) and subsequently comparing the second set of promotions to the stored first set of promotions. Thus, according to such embodiments the processing element 20 of the product availability and purchasing system 12 may indicate to the user when there is a difference between the first and second set of promotions or when new promotional information (corresponding to an upgrade or other promotional offer that was not previously offered) is made available for the selected product option at some point after the initial purchase of the product option.

For example, the user may purchase a selected product option (such as a compact rental car) having a corresponding promotional offer (such as a free upgrade to a midsize rental). As described above, the user may commission the product availability and purchasing system 12 to store the purchase information related to the selected product option and to subsequently and periodically interrogate (in a pull configuration) the product source systems 16 (operated by various car rental companies, for example) for current promotional offers associated with the rental of the selected product option (a compact car) or receive pricing and option updates from the product source systems when there has been a change in price or options (in a push configuration). If, during the interrogation period, the processing element 20 identifies a different second promotional offer (such as a free upgrade to a full-size rental) the product availability and purchasing system may indicate such a difference to the user. Furthermore, in some embodiments, the processing element may further determine if the second set of promotions are greater in value than the first set of promotions and subsequently alter the first set of promotions associated with the selected product option such that the first set of promotions at least partially reflect the second set of promotions. For example, in the above-described scenario, the processing element 20 may provide the user with a compact car rental and subsequently provide a free upgrade to a full-size car rental (instead of the free upgrade to a mid-size rental that was originally received by the user at the time the selected product option was purchased).

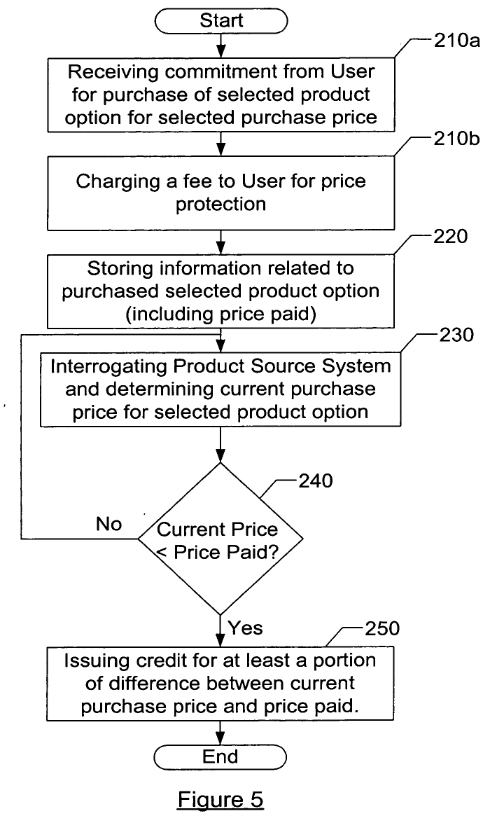

The present invention also includes various method embodiments for monitoring a product database (such as a product source system 16 and/or CRS) for changes in price and promotional offers corresponding to a product option purchased by a user. These embodiments are shown generally in FIGS. 3-5. According to one embodiment, as shown generally in FIG. 3, step 210 of the method comprises receiving a commitment from a user to purchase a selected product for a corresponding selected purchase price. Step 210 may comprise, for example, receiving, at a product availability and purchasing system housed in a host computer 12, an online payment from a user (via an interface 18 in communication with the host computer 12 via a network 14 in order to reserve a round-trip travel ticket corresponding to a selected travel itinerary. As shown in FIG. 5, step 210 may comprise component steps 210a and 210b wherein step 210a comprises receiving a purchase commitment as well as an additional purchase option that includes the interrogating and comparing services (see steps 230-240 of FIGS. 3-5) provided by the systems, method, and computer program products of the present invention. Furthermore, step 210b comprises charging the user a fee for the purchase option. Thus, the user may choose (via, the interface 18, for example) at the time of purchase of a selected product option (such as a ticket for a travel itinerary) whether or not to purchase the product option of activating the processing element 20 of the product availability and purchasing system 12 to interrogate various product source systems 16 to search for current purchase prices lower that the price paid for the selected product option. Upon purchasing such as product option, the processing element 20 may then activate the accounting system 17 to charge the user a fee for the price-comparison purchase option offered by the system 10, methods, and computer program products of the present invention. According to some -method embodiments, the fee charged for the purchase option may be varied based on the purchase date of the product option and an intended use date of the selected product option by the user. In some method embodiments, the fee charged for the purchase option may also be varied based on factors such as the purchase price of the product option (flat or percentage based on purchase price) or the product option type (such as fare type (refundable/nonrefundable/excursion, etc.) international/domestic itinerary, round-trip/one-way/multi-city itinerary, product option provider (air carrier, hotelier, etc.), product option “bundle” (i.e., with a cruise, hotel, or other product option)). In addition, according to some embodiments, the fee charged for the purchase option may also be varied based on: the passenger type (i.e., senior, adult, child), the number of passengers, and/or a purchaser profile (i.e., elite status, preferred status, first-time purchaser, etc.).

Step 220 of the method embodiment of FIG. 2 comprises storing information concerning the purchase (including the purchase price paid by the user), in a storage device. In some embodiments (as described above), the storage device may comprise a memory device 22 in communication with and/or operably engaged with the host computer 12 housing the product availability and purchasing system. The storing step of some method embodiments may also comprise storing availability and pricing information from various product source systems 16 that may be in communication with a product availability and purchasing system 12 (and a memory device 22 included therein). Thus, the product availability and purchasing system 12 may periodically download and store current pricing and promotional information corresponding to the selected product option purchased by the user and subsequently interrogates the downloaded information such that the product source systems 16 are not overly burdened by the interrogation of the product availability and purchasing system 12. For example, the product availability and purchasing system 12 may selectively download or transfer current pricing and promotional information for the selected product options at one or more non-peak usage times such that the various product source systems are not burdened during peak usage hours (such as the middle of a workday) by the interrogation and subsequent comparisons performed by the product availability and purchasing system 12 as part of steps 230-240.

Step 230 comprises interrogating a product source system 16 (such as a CRS or other reservation system) and determining a current purchase price for the selected product option. As described above with respect to the system 10 embodiments of the present invention, the product availability and purchasing system 12 may be in communication with various product source systems 16 via a network 14). In addition, in some embodiments, step 230 may comprise determining current purchase price and promotional information for a selected product option that has been previously downloaded by the product availability and purchasing system 12 and subsequently stored in an availability cache 30 within the memory device 22 of a host computer. In addition, according to some method embodiments, the interrogating step shown generally in step 230 may also comprise periodically the product source systems 16 for updates on current purchase price and promotional information for the selected product option during a specified time period subsequent to the purchase date of the selected product option. In additional method embodiments, the specified time period for interrogating under step 230 may end prior to the date of use of the purchased product, wherein the date of use may be, for example, the date of departure in a travel itinerary, check-in date at a hotel, pick-up date for a rental car, or another date of use specific to the selected product.

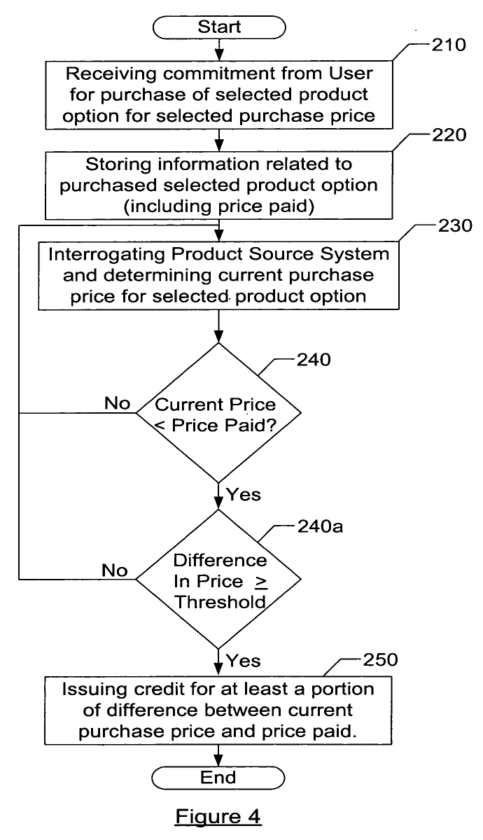

Step 240 comprises comparing the current purchase price (retrieved during interrogation of the product source system 16 in step 230) to the purchase price paid by the user for the selected product option (stored in a memory device 22 of the host computer 12 in step 220). According to some method embodiments, as shown generally in step 240a of FIG. 4, the comparing step may further comprise comparing the difference between the current purchase price and price paid for the selected product option to a threshold price difference such that if the difference is less than the threshold, subsequent step 250 (issuing a credit) does not occur, and if the difference is greater than the threshold, the method proceeds to step 250 (described in detail below).

Finally, as shown in FIG. 3, step 250 comprises issuing a credit (for at least a portion of the difference in price determined in step 240) to the user in cases where the current purchase price is less than the purchase price paid. According to some method embodiments, step 250 may not be performed until the user commences the use of at least one usable portion of the selected product option. For example, according to the method shown generally in FIG. 3, the issuing a credit step 250 may not occur for a user who has purchased a travel ticket and does not actually use the ticket to travel on the outbound leg of the selected travel itinerary. Thus, the methods of the present invention may, in some embodiments, effectively condition the issuance of a credit (based on the interrogation and comparison of pricing and promotional offers) on the actual use of the selected product option by the user.

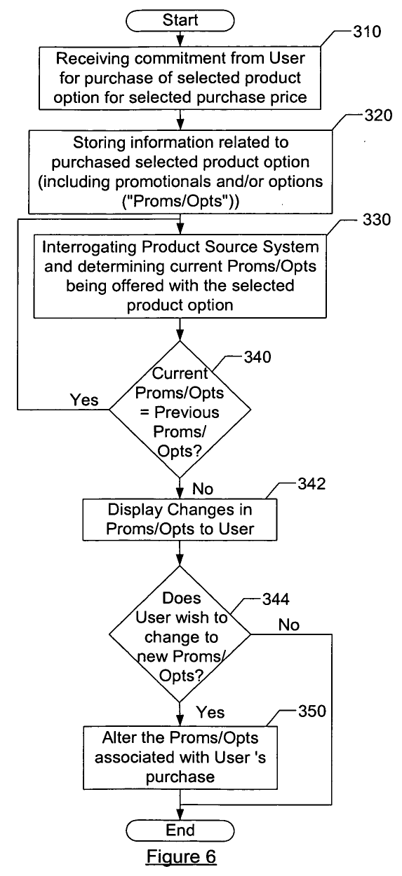

FIG. 6 illustrates an embodiment of the systems and methods of the present invention where changes in options and/or promotionals associated with a purchase are monitored. As in the case of the system embodiments of the present invention (discussed above with reference to FIGS. 1a-1b) the storing step (see generally step 320) of the methods of the present invention may also comprise storing a first set of promotional information offered with the selected product option at the time of purchase in the memory device 22 of the host computer 12. In addition, the interrogating step (see generally, step 330) may further comprise interrogating the product source systems 16 to determine a second set of promotions (that may be currently offered with the selected product option). (When operated in a push mode, the method does not interrogate the product source systems. Instead, the product source systems will send information when product price changes or other offer changes occur.). Furthermore, some method embodiments, in the comparing step 340 may further comprise comparing the second set of promotions to the stored first set of promotions. Thus, according to such alternative method embodiments the processing element 20 of the product availability and purchasing system 12 may indicate to the user when there is a difference between the first and second set of promotions. (See step 350).

For example, the user may purchase a selected product option (step 310, for example) (such as a one-night hotel reservation) having a corresponding promotional offer (such as a free city tour with purchase of a one-night hotel stay). As described above, the user may commission the product availability and purchasing system 12 (shown generally in steps 210a/210b of FIG. 5) to store (step 320) the purchase information related to the selected product option and to subsequently and periodically interrogate (step 330) the product source systems 16 (operated by various hotels having a similar rating or price point to the selected product option) for current promotional offers associated with a particular hotel reservation (one-night hotel stay). If, during the interrogation period, the processing element 20 identifies a different second promotional offer (such as a free two-day car rental with one-night hotel stay) the product availability and purchasing system 12 may indicate such a difference to the user. Furthermore, in some embodiments, the processing element 20 may further determine if the second set of promotions are greater in value than the first set of promotions and subsequently alter the first set of promotions associated with the selected product option such that the first set of promotions at least partially reflect the second set of promotions. (See step 340). For example, in the above-described scenario, the processing element 20 may provide the user with a one-night hotel stay and subsequently provide a free two-day car rental (instead of the free city tour that was originally received by the user at the time the selected product option was purchased (assuming that the car rental has greater value than the city tour). In most instances, the system does not immediately change the user's purchase options. Instead, the system will typically post the change in options to the user in the form of web page or email, and will allow the user to decide whether to take the new options or retain the options originally purchased. (See step 342). Further, it is not necessary that the newly offered promotions and/or options be of greater value. The system may issue an indication to the user any time a promotion and/or option is offered, so that the user can decide whether the initially purchased promotions and/or options are better than the new ones being offered. If the user wishes to accept the new options, the system will change the options associated with the user's purchase. (See step 350).

In addition to providing systems and methods, the present invention also provides computer program products for performing the operations described above. The computer program products have a computer readable storage medium having computer readable program code means embodied in the medium. With reference to FIG. 1B, the computer readable storage medium may be part of the memory device 22, and may implement the computer readable program code means to perform the above discussed operations.

In this regard, FIGS. 3-6 are block diagram, flowchart and control flow illustrations of methods, systems and program products according to exemplary embodiments of the invention. It will be understood that each block or step of the block diagram, flowchart and control flow illustrations, and combinations of blocks in the block diagram, flowchart and control flow illustrations, can be implemented by computer program instructions. These computer program instructions may be loaded onto a computer or other programmable apparatus to produce a machine, such that the instructions which execute on the computer or other programmable apparatus create means for implementing the functions specified in the block diagram, flowchart or control flow block(s) or step(s). These computer program instructions may also be stored in a computer-readable memory that can direct a computer or other programmable apparatus to function in a particular manner, such that the instructions stored in the computer-readable memory produce an article of manufacture including instruction means which implement the function specified in the block diagram, flowchart or control flow block(s) or step(s). The computer program instructions may also be loaded onto a computer or other programmable apparatus to cause a series of operational steps to be performed on the computer or other programmable apparatus to produce a computer implemented process such that the instructions which execute on the computer or other programmable apparatus provide steps for implementing the functions specified in the block diagram, flowchart or control flow block(s) or step(s).

Accordingly, blocks or steps of the block diagram, flowchart or control flow illustrations support combinations of means for performing the specified functions, combinations of steps for performing the specified functions and program instruction means for performing the specified functions. It will also be understood that each block or step of the block diagram, flowchart or control flow illustrations, and combinations of blocks or steps in the block diagram, flowchart or control flow illustrations, can be implemented by special purpose hardware-based computer systems which perform the specified functions or steps, or combinations of special purpose hardware and computer instructions.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A system for monitoring a product database for changes in price corresponding to a product option purchased by a user, the system comprising:
a product source system comprising product options information concerning one or more products;
an accounting system for receiving payments from users for product options selected for purchase;
an interface capable of receiving input from a user concerning purchase of a selected product option; and
a product availability and purchasing system in communication with said product source system, accounting system, and interface comprising:
a memory device for storing purchase information related to products purchased by a user; and
a processing element in communication with said interface and said product source system for determining availability and pricing for the selected product option received from said interface and for storing purchasing information, including the purchase price paid by the user, in a first data set in said memory associated with the selected product option,
wherein said processing element subsequently determines a current purchase price for the selected product option and compares the current purchase price to the stored purchase price paid by the user for the selected product option to determine a difference in price, and
wherein if said current purchase price is less than the purchase price paid by the user, said processor activates said accounting system to issue a credit for at least a portion of the difference in price.

2. A system according to claim 1, wherein said processing element compares the difference in current purchase price and the purchase price paid by the user to a threshold value and issues a credit to the user if the difference is at least equal to the threshold.

3. A system according to claim 1, wherein said processing element interrogates said product source for updates on current purchase price for the selected product option periodically during a specified time period subsequent to a purchase date of the selected option

4. A system according to claim 3, wherein said processing element interrogates said product source during the specified time period, wherein the specified time period ends prior to the use of the purchased product.

5. A system according to claim 1, wherein said product source system periodically transmits a current purchase price for the selected product option to said processing element.

6. A system according to claim 1, wherein said product source system transmits a current purchase price for the selected product option to said processing element when the purchase price changes.

7. A system according to claim 1, wherein the selected product option is divided into separate usable portions, and wherein said processing element only applies a credit after the user has commenced use of the one of the usable portions of the selected product option.

8. A system according to claim 1, wherein the process of comparing the stored purchase price paid by the user to the current purchase price is designated as a purchase option associated with the selected product option and charges a fee to the user for the purchase option.

9. A system according to claim 8, wherein the fee for the purchase option is varied by said product availability and purchasing system based on at least one of:
the purchase date of the product option and a intended use date of the selected product option by the user;
the purchase price paid by the user for the product option;
a product option type:
a passenger type;
a number of passengers; and
a purchaser profile.

10. A system according to claim 1, wherein said product source system comprises a data cache for storing product availability and pricing information received from other product source systems.

11. A system according to claim 1, wherein said product source system is a computer reservation system.

12. A method for monitoring a product database for changes in price corresponding to a product option purchased by a user, the method comprising:
receiving from a user a commitment to purchase a selected product for a selected purchase price;
storing information concerning the purchase, including the purchase price paid by the user, in a storage device;
following the purchase of the product, subsequently determining a current purchase price for the selected product option;
comparing the current purchase price to the stored purchase price paid by the user for the selected product option to determine a difference in price, and
wherein if said current purchase price is less than the purchase price paid by the user, issuing a credit for at least a portion of the difference in price.

13. A method according to claim 12, wherein said comparing comprises comparing the difference in current purchase price and the purchase price paid by the user to a threshold value and wherein said issuing comprises issuing a credit to the user if the difference is at least equal to the threshold.

14. A method according to claim 12, wherein said interrogating comprises interrogating the product source for updates on current purchase price for the selected product option periodically during a specified time period subsequent to a purchase date of the selected option.

15. A method according to claim 14, wherein said interrogating comprises interrogating the product source during the specified time period, wherein the specified time period ends prior to the use of the purchased product.

16. A method according to claim 12 further comprising transmitting from the product source periodically a current purchase price for the selected product option.

17. A method according to claim 12 further comprising transmitting from the product source a current purchase price for the selected product option when the purchase price changes.

18. A method according to claim 12, wherein the selected product option is divided into separate usable portions, and wherein said issuing comprises issuing a credit after the user has commenced use of the one of the usable portions of the selected product option.

19. A method according to claim 12, wherein the process of comparing the stored purchase price paid by the user to the current purchase price is designated as a purchase option associated with the selected product option, said method further comprising charging a fee to the user for the purchase option.

20. A method according to claim 19 further comprising varying the fee for the purchase option based on at least one of:
the purchase date of the product option and a intended use date of the selected product option by the user;
the purchase price paid by the user for the product option;
a product option type:
a passenger type;
a number of passengers; and
a purchaser profile.

21. A method according to claim 12 further comprising storing product availability and pricing information received from other product source systems.

22. A computer program product for monitoring a product database for changes in price corresponding to a product option purchased by a user, said computer program product comprising a computer-readable storage medium having computer-readable program code portions stored therein, the computer-readable program code portions comprising:
first computer instruction means for receiving from a user a commitment to purchase a selected product for a selected purchase price;
second computer instruction means for storing information concerning the purchase, including the purchase price paid by the user, in a storage device;
following the purchase of the product, third computer instruction means for determining a current purchase price for the selected product option;
fourth computer instruction means for comparing the current purchase price to the stored purchase price paid by the user for the selected product option to determine a difference in price, and
wherein if said current purchase price is less than the purchase price paid by the user, fifth computer instruction means for issuing a credit for at least a portion of the difference in price.

23. A computer program product according to claim 22, wherein said fourth computer instruction means compares the difference in current purchase price and the purchase price paid by the user to a threshold value and wherein said fifth computer instruction means issues a credit to the user if the difference is at least equal to the threshold.

24. A computer program product according to claim 22, wherein said third computer instruction means interrogates the product source for updates on current purchase price for the selected product option periodically during a specified time period subsequent to a purchase date of the selected option.

25. A computer program product according to claim 24, wherein said third instruction means interrogates the product source during the specified time period, wherein the specified time period ends prior to the use of the purchased product.

26. A computer program product according to claim 22 comprising sixth computer instruction means for periodically transmitting a current purchase price for the selected product option from the product source.

27. A computer program product according to claim 22 comprising sixth computer instruction means for transmitting a current purchase price for the selected product option from the product source when the purchase price changes.

28. A computer program product according to claim 22, wherein the selected product option is divided into separate usable portions, and wherein said fifth instruction means issues a credit after the user has commenced use of the one of the usable portions of the selected product option.

29. A computer program product according to claim 22, wherein the process of comparing the stored purchase price paid by the user to the current purchase price is designated as a purchase option associated with the selected product option, said computer program product further comprising seventh instruction means for charging a fee to the user for the purchase option.

30. A computer program product according to claim 29 further comprising eighth computer instruction means for varying the fee for the purchase option based on at least one of:
the purchase date of the product option and a intended use date of the selected product option by the user;
the purchase price paid by the user for the product option;
a product option type:
a passenger type;
a number of passengers; and
a purchaser profile.

31. A computer program product according to claim 30 further comprising ninth computer instruction means for storing product availability and pricing information received from other product source systems.

32. A system for monitoring a product database for changes in a status corresponding to a product option purchased by a user where various promotional offers may be associated with the product option and changed from time to time, the system comprising:
a product source system comprising product options information concerning one or more products, wherein the information may include promotional offers associated with the product;
an accounting system for receiving payments from users for product options selected for purchase;
an interface capable of receiving input from a user concerning purchase of a selected product option; and
a product availability and purchasing system in communication with said product source system, accounting system, and interface comprising:
a memory device for storing purchase information related to products purchased by a user; and
a processing element in communication with said interface and said product source system for determining availability and pricing for the selected product option received from said interface and for storing purchasing information, including a first set of promotional information offered with the product option at the time of purchase, in said memory associated with the selected product option,
wherein said processing element subsequently determines a second set of promotions currently offered with the selected product option and compares the second set of promotions to the stored first set of promotions and indicates when there is a difference between the first and second sets of promotions.

33. A system according to claim 32, wherein if said processing element determines that the second set of promotions are more valuable than the first set of promotions, said processing element alters the first set of promotions associated with the selected product option at least partially reflect the second set of promotions.

34. A system according to claim 32, wherein one of the promotions is price, wherein if said current purchase price is less than the purchase price paid by the user, said processor activates said accounting system to issue a credit for at least a portion of the difference in price.

35. A system according to claim 32, wherein said processing element interrogates said product source for updates on current promotions offered for the selected product option periodically during a specified time period subsequent to a purchase date of the selected option.

36. A system according to claim 35, wherein said processing element interrogates said product source during the specified time period, wherein the specified time period ends prior to the use of the purchased product.

37. A system according to claim 32, wherein the selected product option is divided into separate usable portions, and wherein said processing element only alters the first set of promotions associated with the selected product option at least partially reflect the second set of promotions after the user has commenced use of the one of the usable portions of the selected product option.

38. A system according to claim 32, wherein the process of comparing the first and second sets of promotions is designated as a purchase option associated with the selected product option and said processing element charges a fee to the user for the purchase option.

39. A system according to claim 38, wherein the fee for the purchase option is varied by said product availability and purchasing system based on at least one of:
the purchase date of the product option and an intended use date of the selected product option by the user;
the purchase price paid by the user for the product option;
a product option type:
a passenger type;
a number of passengers; and
a purchaser profile.

40. A system according to claim 32, wherein said product source system comprises a data cache for storing product availability and promotional information received from other product source systems.

41. A system according to claim 32, wherein said product source system is a computer reservation system.

42. A method for monitoring a product database for changes in price corresponding to a product option purchased by a user, the system comprising:
receiving from a user a commitment to purchase a selected product having associated therewith a first set of promotions;
storing information concerning the purchase, including the first set of promotions, in a storage device;
following the purchase of the product, subsequently determining a current second set of promotions offered with the selected product option;
comparing the current second set of promotions with the first set of promotions for the selected product option, and
indicating when there is a difference between the first and second sets of promotions.

43. A method according to claim 42, wherein if the second set of promotions are more valuable than the first set of promotions, said method further comprises altering the first set of promotions associated with the selected product option at least partially reflect the second set of promotions.

44. A method according to claim 43, wherein one of the promotions is price, wherein if said current purchase price is less than the purchase price paid by the user, said altering further comprises issuing a credit for at least a portion of the difference in price.

45. A method according to claim 42, wherein said interrogating further comprises interrogating the product source for updates on current promotions offered for the selected product option periodically during a specified time period subsequent to a purchase date of the selected option.

46. A method according to claim 45, wherein said interrogating further comprises interrogating the product source during the specified time period, wherein the specified time period ends prior to the use of the purchased product.

47. A method according to claim 43, wherein the selected product option is divided into separate usable portions, and wherein altering only alters the first set of promotions associated with the selected product option to at least partially reflect the second set of promotions after the user has commenced use of the one of the usable portions of the selected product option.

48. A method according to claim 42, wherein the process of comparing the first and second sets of promotions is designated as a purchase option associated with the selected product option, further comprising charging a fee to the user for the purchase option.

49. A method according to claim 48, wherein the fee for the purchase option is varied by said product availability and purchasing system based on at least one of:
the purchase date of the product option and a intended use date of the selected product option by the user;
the purchase price paid by the user for the product option;
a product option type:
a passenger type;
a number of passengers; and
a purchaser profile.

50. A method according to claim 42 further comprises storing in a data cache product availability and promotional information received from other product source systems.

51. A computer program product for monitoring a product database for changes in price corresponding to a product option purchased by a user, said computer program product comprising a computer-readable storage medium having computer-readable program code portions stored therein, the computer-readable program code portions comprising:
first computer instruction means for receiving from a user a commitment to purchase a selected product having associated therewith a first set of promotions;
second computer instruction means for storing information concerning the purchase, including the first set of promotions, in a storage device;
third computer instruction means for determining a current second set of promotions offered with the selected product option;
fourth computer instruction means for comparing the current second set of promotions with the first set of promotions for the selected product option, and
fifth computer instruction means for indicating when there is a difference between the first and second sets of promotions.

52. A computer program product according to claim 51, wherein if the second set of promotions are more valuable than the first set of promotions, said computer program product further comprising sixth computer instructions means for altering the first set of promotions associated with the selected product option at least partially reflect the second set of promotions.

53. A computer program product according to claim 52, wherein one of the promotions is price, wherein if said current purchase price is less than the purchase price paid by the user, said sixth computer instruction means issues a credit for at least a portion of the difference in price.

54. A computer program product according to claim 51, wherein said third computer instruction means interrogates the product source for updates on current promotions offered for the selected product option periodically during a specified time period subsequent to a purchase date of the selected option.

55. A computer program product according to claim 54, wherein said third computer instruction means interrogates the product source during the specified time period, wherein the specified time period ends prior to the use of the purchased product.

56. A computer program product according to claim 52, wherein the selected product option is divided into separate usable portions, and wherein sixth computer instructions means alters the first set of promotions associated with the selected product option at least partially reflect the second set of promotions after the user has commenced use of the one of the usable portions of the selected product option.

57. A computer program product according to claim 51, wherein the process of comparing the first and second sets of promotions is designated as a purchase option associated with the selected product option, further comprising seventh computer instructions means for charging a fee to the user for the purchase option.

58. A computer program product according to claim 57, further comprising eighth computer instruction means for varying the fee for the purchase option based on at least one of:
the purchase date of the product option and an intended use date of the selected product option by the user;
the purchase price paid by the user for the product option;
a product option type:
a passenger type;
a number of passengers; and
a purchaser profile.

59. A computer program product according to claim 51 further comprises ninth computer instructions means for sorting in a data cache product availability and promotional information received from other product source systems.

60. A system for monitoring a product database for changes to product offerings concerning a product, the system comprising:
a product source system comprising product offerings information concerning one or more products;
an interface capable of receiving input from a user;
a memory device; and
a processing element in communication with said interface, product source system
wherein said processing element receives a request from a user via said interface to monitor one or more selected products,
wherein said processing element stores in said memory device information relating to the product offerings for the one or more selected products indicated by the user,
wherein said processing element compares product offering for the one or more selected products at a subsequent date with the product offerings previously stored and if there is a difference in the product offerings, said processing element provides an indication that a difference exists.

61. A system according to claim 60, wherein the product offerings associated with the product comprises a price for the product.

62. A system according to claim 60, wherein said processing element stores purchasing information related to the one or mored selected product, including the purchase price paid by the user, in a first data set in said memory,
wherein said processing element determines a current purchase price for the selected product option and compares the current purchase price to the stored purchase price paid by the user for the selected product option to determine a difference in price, and
wherein if said current purchase price is less than the purchase price paid by the user, said processor issues a credit for at least a portion of the difference in price.

63. A method for monitoring a product database for changes to product offerings concerning a product, the method comprising:
receiving a request from a user to monitor one or more selected products;
storing information relating to the product offerings for the one or more selected products indicated by the user;
comparing product offering for the one or more selected products at a subsequent date with the product offerings previously stored and if there is a difference in the product offerings, said processing element; and
providing an indication that a difference exists.

64. A method according to claim 63, wherein the product offerings associated with the product comprises a price for the product.

65. A method according to claim 64, wherein said storing step comprising storing purchasing information related to the one or mored selected product, including the purchase price paid by the user, in a first data set in a memory, said method further comprising:
determining a current purchase price for the selected product option;
comparing the current purchase price to the stored purchase price paid by the user for the selected product option to determine a difference in price; and
wherein if said current purchase price is less than the purchase price paid by the user, issuing a credit for at least a portion of the difference in price.

66. A computer program product for monitoring a product database for changes in price corresponding to a product option purchased by a user, said computer program product comprising a computer-readable storage medium having computer-readable program code portions stored therein, the computer-readable program code portions comprising:
first computer instruction means for receiving a request from a user to monitor one or more selected products;
second computer instruction means for storing information relating to the product offerings for the one or more selected products indicated by the user;
third computer instruction means for comparing product offering for the one or more selected products at a subsequent date with the product offerings previously stored and if there is a difference in the product offerings, said processing element; and
fourth computer instruction means for providing an indication that a difference exists.

67. A computer program product according to claim 66, wherein the product offerings associated with the product comprises a price for the product.

68. A computer program product according to claim 66, wherein said second computer instruction means stores purchasing information related to the one or mored selected product, including the purchase price paid by the user, in a first data set in a memory, said computer readable medium further comprising:
fifth computer instruction means for determining a current purchase price for the selected product option;
sixth computer instruction means for comparing the current purchase price to the stored purchase price paid by the user for the selected product option to determine a difference in price; and
wherein if said current purchase price is less than the purchase price paid by the user, seventh computer instruction means for issuing a credit for at least a portion of the difference in price.
